(19) United States
(12) Patent Application Publication
(10) Pub. No.: US 2026/0356132 A1
(43) Pub. Date: Nov. 12, 2026

(54) TIRE

(71) Applicant: The Yokohama Rubber Co., LTD., Kanagawa (JP)

(72) Inventor: Ryota ASA, Kanagawa (JP)

(21) Appl. No.: 19/515,074

(22) PCT Filed: Aug. 14, 2024
(86) PCT No.: PCT/JP2024/029007

§ 371 Date: Feb. 27, 2026

(30) Foreign Application Priority Data
Sep. 11, 2023 (JP) 2023-146988

(51) Int. Cl. B60C 13/00

(52) U.S. Cl. CPC B60C 13/001

(57) ABSTRACT

A pneumatic tire includes: a ridge region formed on a tire side portion, which is a surface of a sidewall portion, a plurality of ridges being arranged in the ridge region; and a plurality of projection patterns arranged in the ridge region, each having a height in a height direction of the ridges greater than a height of the ridges, and extending in a direction intersecting an extension direction of the ridges. The plurality of projection patterns include a projection pattern in contact with a contour portion of the ridge region on an outer side in a tire radial direction and a projection pattern spaced apart from the contour portion of the ridge region.

### TECHNICAL FIELD

The present technology relates to a tire.

### BACKGROUND ART

Some recent tires are provided with decorative projection patterns on the surfaces of sidewall portions to improve appearance. For example, in the pneumatic tire described in Japan Patent Nos. 5325129 B, 3614973 B, 6047016 B, and 4640517 B and in Japan Unexamined Patent Publication No. 2006-347202 A, decorative portions having ridges are provided on the surfaces of sidewall portions.

However, applying a complicated pattern to the sidewall portion leads to deterioration of workability in processing the mold used for molding the tire. Thus, the decorative pattern applied to the sidewall portion is preferably a pattern that can be formed with as less man-hours as possible. However, the decorative pattern being simple may make it difficult to improve the appearance even by applying decoration to the sidewall portion.

It is important that the appearance of the tire can be maintained not only when the tire is new but also during use when the tire is exposed to an outdoor environment for a long time. That is, when the tire is used, cracks may occur on the surface of the sidewall portion due to a load acting on the sidewall portion, aging deterioration, or the like. When cracks occur on the surface of the sidewall portion, the appearance of the tire deteriorates, and it is difficult to maintain the appearance continuously. As a result, when the sidewall portion is decorated, it is difficult to maintain the appearance continuously while reducing deterioration in molding processability.

### SUMMARY

The present technology provides a tire capable of reducing deterioration in molding processability and maintaining the appearance continuously by reducing extension of cracks.

A tire according to an embodiment of the present technology includes: a ridge region formed on a tire side portion, which is a surface of a sidewall portion, a plurality of ridges being arranged in the ridge region; a plurality of projection patterns arranged in the ridge region, each having a height in a height direction of the ridges greater than a height of the ridges, and extending in a direction intersecting an extension direction of the ridges. The plurality of projection patterns include a projection pattern in contact with a contour portion of the ridge region on an outer side in a tire radial direction and a projection pattern spaced apart from the contour portion of the ridge region.

In the above tire, preferably, a smooth surface region, which is a planar region having a height in the height direction of the ridges greater than the height of the ridges, is formed in the tire side portion, and
the projection pattern has a height in the height direction of the ridges within a range of ±0.80 mm of the height of the smooth surface region.

In the above tire, the projection patterns adjacent to each other are preferably arranged in parallel.

In the above tire, each of the plurality of ridges arranged in the ridge region preferably has a pitch P in a range 0.55 mm≤P≤1.50 mm and a ratio H/B of the height H of the ridge to the width B of the ridge in a range 0.60≤H/B≤1.40.

In the above tire, in the projection patterns, a broad width portion and a narrow width portion having a width in a direction intersecting the extension direction of the projection patterns smaller than a width of the broad width portion are preferably alternately formed in the extension direction of the projection patterns.

In the above tire, the projection pattern preferably has a ratio d/D of a width d of the narrow width portion to the width D of the broad width portion in a range 0.10≤d/D≤0.50.

In the above tire, each of the plurality of projection patterns preferably has a pitch X in a range 1.00 mm≤X≤5.00 mm.

In the above tire, preferably, the projection patterns adjacent to each other are arranged in parallel, and each of the plurality of projection patterns has a ratio D/X of a width D of the broad width portion to a pitch X in a range 0.20≤D/X≤5.00.

In the above tire, the projection pattern preferably has a length L1 of the broad width portion and a length L2 of the narrow width portion in the extension direction of the projection pattern satisfying a relationship 0.30≤L1/(L1+L2)≤0.70.

In the above tire, preferably, each of the plurality of projection patterns includes a portion in which the broad width portion of one of the adjacent projection patterns and the narrow width portion of the other of the adjacent projection patterns are at the same position in the tire radial direction.

The tire according to an embodiment of the present technology has an advantageous effects of suppressing crack extension and continuously maintaining appearance, while suppressing deterioration of molding processability.

### BRIEF DESCRIPTION OF DRAWINGS

FIG. 1 is a meridian cross-sectional view illustrating a main portion of a pneumatic tire according to an embodiment.

FIG. 2 is a view taken along line A-A of FIG. 1.

FIG. 3 is a view taken along line A-A of FIG. 1, and is an explanatory diagram illustrating a state in which the ridges in the ridge region are omitted.

FIG. 4 is a detailed view of a portion B of FIG. 2.

FIG. 5 is a cross-sectional view of ridges along the extension direction of the ridges.

FIG. 6 is a detailed view of the portion B in FIG. 2, and is an explanatory diagram illustrating a state in which the ridges in the ridge region are omitted.

FIG. 7 is a cross-sectional view schematically illustrating a mold for molding a tire, which is a part of a system for manufacturing a pneumatic tire.

FIG. 8 is a modified example of a pneumatic tire according to an embodiment, and is an explanatory diagram illustrating a case in which a projection pattern arranged in a ridge region is formed with a constant width.

FIGS. 9A-9B include tables describing a result of a performance evaluation test of a pneumatic tire.

### DETAILED DESCRIPTION

Hereinafter, a tire according to an embodiment of the present technology will be described in detail with reference to the drawings. However, the technology is not limited to the embodiment. The components in the following embodiment include those which are replaceable and easily conceivable by a person skilled in the art, or those which are substantially the same.

### Embodiments

### Pneumatic Tire

In the following description, a pneumatic tire 1 is used as an example of a tire according to an embodiment of the present technology. The pneumatic tire 1 as an example of a tire can be filled with air, an inert gas such as nitrogen, and other gases.

Hereinafter, the term “tire radial direction” refers to a direction orthogonal to a tire rotation axis (not illustrated) that is a rotation axis of the pneumatic tire 1, the term “inner side in a tire radial direction” refers to a side toward the tire rotation axis in the tire radial direction, and the term “outer side in the tire radial direction” refers to a side away from the tire rotation axis in the tire radial direction. The tire circumferential direction refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions located on the outermost sides in the tire width direction, or in other words, the distance between the portions that are the most distant from the tire equatorial plane CL in the tire width direction. The term “tire equator line” refers to a line in the tire circumferential direction of the pneumatic tire 1 that lies on the tire equatorial plane CL. In the description below, “tire meridian cross-section” refers to a cross-section of the tire taken along a plane including the tire rotation axis.

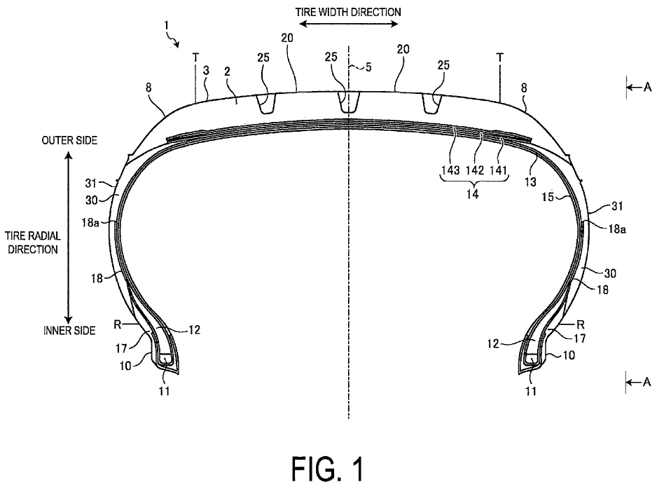

FIG. 1 is a meridian cross-sectional view illustrating a main portion of a pneumatic tire according to an embodiment. The pneumatic tire 1 illustrated in FIG. 1 includes a tread portion 2 disposed at the outermost portion of the pneumatic tire 1 in the tire radial direction, when viewed in the meridian cross-section. The surface of the tread portion 2, in other words, a portion that comes into contact with a road surface when a vehicle (not illustrated) equipped with the pneumatic tire 1 travels is formed as a tread surface 3. A plurality of circumferential main grooves 25 extending in the tire circumferential direction are formed in the tread surface 3 of the tread portion 2, and a plurality of land portions 20 are defined in the tread surface 3 by circumferential main grooves 25. Grooves other than the circumferential main grooves 25 may be formed in the tread surface 3, and lug grooves (not illustrated) extending in the tire width direction or narrow grooves (not illustrated) different from the circumferential main grooves 25 may be formed.

Shoulder portions 8 are located at both ends of the tread portion 2 in the tire width direction, and sidewall portions 30 are arranged on the inner side of the shoulder portion 8 in the tire radial direction. That is, the sidewall portions 30 are arranged at 2 locations on both sides of the pneumatic tire 1 in the tire width direction. The outer surfaces of the sidewall portions 30 are formed as tire side portions 31, which are located on both sides in the tire width direction. Each of the two tire side portions 31 in the sidewall portions 30 faces the side opposite to where a tire equatorial plane 5 is located, in the tire width direction.

The tire side portion 31 in this case refers to a uniformly continuous surface in a range of the outer side from a ground contact edge T of the tread portion 2 in the tire width direction and of the outer side from a rim check line R in the tire radial direction. The ground contact edge T refers to both outermost edges in the tire width direction and is continuous in the tire circumferential direction in a region in which the tread surface 3 of the tread portion 2 of the pneumatic tire 1 contacts the road surface when the pneumatic tire 1 is mounted on a regular rim, the regular internal pressure is inflated, and 70% of the regular load is applied. The rim check line R refers to a line for confirming whether the tire is normally mounted and is typically indicated on a front side surface of bead portions 10 as a continuous annular convex line in the tire circumferential direction along a portion approximate to a rim flange (not illustrated) on the outer side in the tire radial direction from the rim flange.

Note that “regular rim R” refers to an “applicable rim” defined by the JATMA (Japan Automobile Tyre Manufacturers Association, Inc.), a “Design Rim” defined by the TRA (Tire and Rim Association, Inc.), or a “Measuring Rim” defined by the ETRTO. The regular internal pressure refers to a “maximum air pressure” defined by the JATMA, a maximum value of “TIRE LOAD LIMITS AT VARIOUS COLD INFLATION PRESSURES” defined by the TRA, or “INFLATION PRESSURES” defined by the ETRTO (European Tyre and Rim Technical Organisation). The regular load refers to a “maximum load capacity” defined by the JATMA, a maximum value in “TIRE LOAD LIMITS AT VARIOUS COLD INFLATION PRESSURES” defined by the TRA, or “LOAD CAPACITY” defined by the ETRTO.

The bead portion 10 is located on an inner side of each of the sidewall portions 30 in the tire radial direction located on both sides in the tire width direction. The bead portions 10 are disposed at two locations on both sides of the tire equatorial plane 5, similarly to the sidewall portions 30. The bead portions 10 each includes a bead core 11, and a bead filler 12 is provided on an outer side of the bead core 11 in the tire radial direction.

A plurality of belt layers 14 is provided on an inner side of the tread portion 2 in the tire radial direction. The belt layers 14 include a plurality of cross belts 141, 142, and a belt cover 143 in a multilayer structure. Of these, the cross belts 141 and 142 are formed by performing a rolling process on a plurality of coating rubber-covered belt cords made of steel or an organic fiber material. The cross belts 141 and 142 have a belt angle of 20° or more and 55° or less as an absolute value. The plurality of cross belts 141 and 142 has different belt angles to each other, which are defined as inclination angles in the fiber direction of the belt cords with respect to the tire circumferential direction, and is formed as a so-called crossply structure in which the belt cords are intersected each other in the fiber direction and layered. The belt cover 143 is made by performing a rolling process on a plurality of coating rubber-covered cords made of steel or an organic fiber material and has a belt angle of 0° or more and 10° or less, as an absolute value. The belt cover 143 is disposed in a multilayer manner on an outer side of the cross belts 141 and 142 in the tire radial direction.

A carcass 13 containing a cord of a radial ply is continuously provided on an inner side of the belt layer 14 in the tire radial direction and on the sidewall portions 30 on the side of the tire equatorial plane 5. The carcass 13 has a single layer structure made of one carcass ply or a multilayer structure with a plurality of carcass plies layered and forms the backbone of the tire extending in a toroidal manner between the bead cores 11 disposed on both sides in the tire width direction. Specifically, the carcass 13 is disposed extending from one bead portion 10 to the other bead portion 10 among the bead portions 10 located on both sides in the tire width direction and turns back toward the outer side in the tire width direction along the bead cores 11 at the bead portions 10 to wrap around the bead cores 11 and the bead fillers 12. The portion of the carcass 13 in which the bead core 11 is wound back along the tire width direction is a turned-up portion 18. The turned-up portion 18 extends to the outer side of the bead filler 12 in the tire radial direction. Thus, an end portion 18a of the turned-up portion 18 on the outer side in the tire radial direction is located on the outer side than the bead filler 12 in the tire radial direction, and is located near the portion of the sidewall portion 30 that is the maximum width of the pneumatic tire 1 in the tire width direction. The carcass ply of the carcass 13 is formed by performing a rolling process on a plurality of coating rubber-covered carcass cords made of steel or an organic fiber material, such as aramid, nylon, polyester, rayon, or the like. The carcass ply is formed to have a carcass angle, which is an inclination angle of the fiber direction of the carcass cords with respect to the tire circumferential direction of 80° or more and 95° or less as an absolute value.

At the bead portion 10, a rim cushion rubber 17 that forms a contact surface of the bead portion 10 with respect to the rim flange is disposed on the inner side in the tire radial direction and on the outer side in the tire width direction, of the bead core 11 and a turned back portion of the carcass 13. An innerliner 15 is formed along the carcass 13, on the inner side or on an inner portion side of the carcass 13 in the pneumatic tire 1.

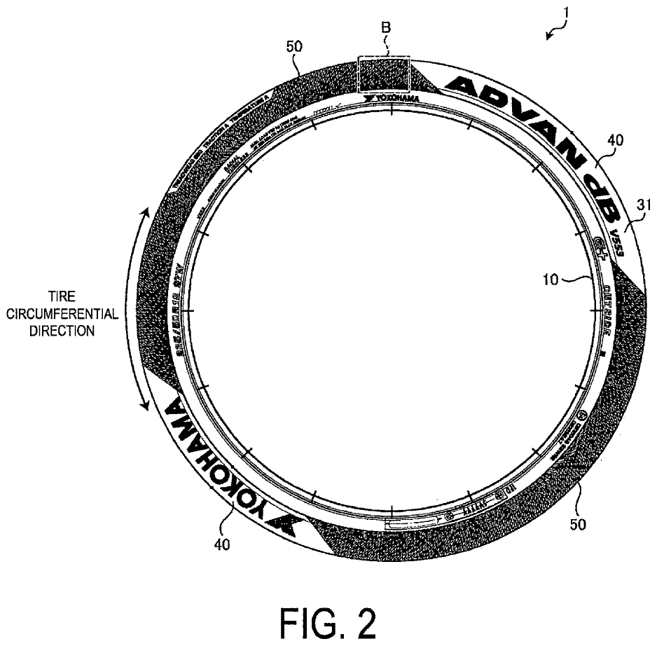

FIG. 2 is a view taken along line A-A of FIG. 1. A smooth surface region 40 and a ridge region 50 are formed in each of the tire side portions 31 located at both positions in the tire width direction for the purpose of improving the appearance of the pneumatic tire 1 and displaying various information. The smooth surface region 40 and the ridge region 50 are provided in the same form with respect to the respective tire side portions 31 on both sides in the tire width direction. Among them, the smooth surface region 40 is a region having a flat surface as a base, and various information for identifying the pneumatic tire 1 or illustrating to a user such as a brand name, a logo mark, a product name, or the like is displayed in the smooth surface region 40.

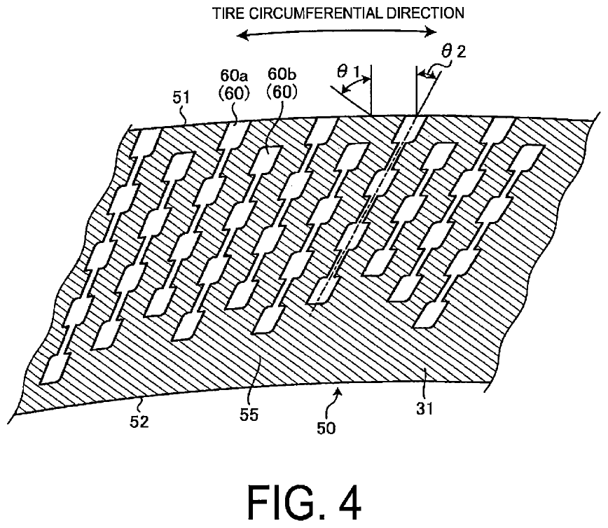

The ridge region 50 is a decorative portion for improving the appearance of the pneumatic tire 1, and a plurality of ridges 55 (see FIG. 4) are arranged in the ridge region 50. The plurality of ridges 55 are arranged over the entire range of the ridge region 50 in the tire circumferential direction. The ridge region 50 has a certain width in the tire radial direction, and is arranged at a position different from a position where the smooth surface region 40 is provided in the tire circumferential direction. Indication of information is appropriately performed not only in the smooth surface region 40 but also in the ridge region 50 as necessary.

In the present embodiment, the smooth surface regions 40 are arranged at 2 locations in the tire circumferential direction of one tire side portion 31, and the ridge regions 50 are arranged at 2 locations between the 2 smooth surface regions 40 in the tire circumferential direction. In other words, the 2 smooth surface regions 40 are each arranged in a region between the 2 ridge regions 50 in the tire side portion 31. The length of the range in which each of the 2 ridge regions 50 is arranged in the tire circumferential direction is similar to each other, and the length of the range in which each of the 2 smooth surface regions 40 is arranged in the tire circumferential direction is also similar to each other. Thus, the ranges in which the 2 smooth surface regions 40 and the 2 ridge regions 50 are arranged in the tire side portion 31 are point symmetrical about the rotation axis of the pneumatic tire 1.

In the present embodiment, the boundary portion between the smooth surface region 40 and the ridge region 50 extends in the tire radial direction and is inclined in the tire circumferential direction. Thus, the smooth surface region 40 and the ridge region 50 overlap in the tire radial direction in the boundary portion between the smooth surface region 40 and the ridge region 50.

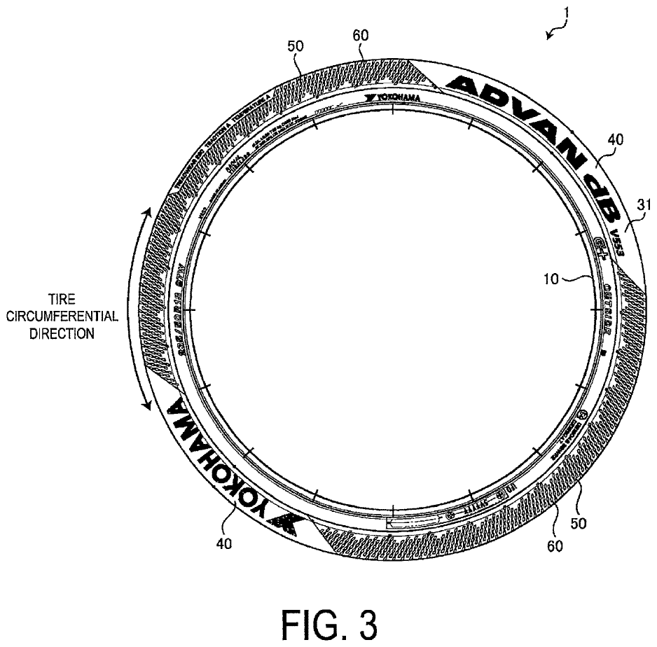

FIG. 3 is a view taken along line A-A of FIG. 1, and is an explanatory diagram illustrating a state in which the ridges 55 in the ridge region 50 are omitted. FIG. 3 omits illustration of the ridges 55 to facilitate recognition of projection patterns 60 arranged in the ridge region 50. In addition to the ridges 55 (see FIG. 4), a plurality of projection patterns 60 are arranged in the ridge region 50. Similar to the ridges 55, the plurality of projection patterns 60 arranged in the ridge region 50 are arranged over the entire range of the ridge region 50 in the tire circumferential direction.

FIG. 4 is a detailed view of the portion B of FIG. 2. The ridge region 50 is provided with a plurality of ridges 55, which extends along the tire side portion 31 in the shape of ridge-like projections and are arranged side by side in the tire circumferential direction. The ridge 55 projects from the tire side portion 31 to the outer side in the tire width direction or to the outer side of the tire in the direction opposite to the tire cavity side, and is provided in and integrally with the tire side portion 31. The ridge 55 has an inclination angle with respect to the tire radial direction or with respect to the tire circumferential direction within a predetermined range. In the ridge region 50, the adjacent ridges 55 are arranged at an angle close to parallel, thus the adjacent ridges 55 are substantially parallel, and the plurality of ridges 55 are arranged at approximately equal intervals in the tire circumferential direction, whereby patterns are formed by the plurality of ridges 55.

The ridge region 50 is arranged along the tire circumferential direction, thus the plurality of ridges 55 arranged in the ridge region 50 are arranged substantially radially. When the relative angle of the adjacent ridges 55 is approximately equal to the relative angle of the arrangement positions of the ridges 55 in the tire circumferential direction, the adjacent ridges 55 are considered to be substantially parallel.

The inclination angle θ1 of each of the plurality of ridges 55 arranged in the ridge region 50 in the tire circumferential direction relative to the tire radial direction is in a range of 10° or more and 70° or less. The inclination angle θ1 of the ridge 55 in the tire circumferential direction with respect to the tire radial direction is preferably in a range of 20° or more and 70° or less.

The projection pattern 60 arranged in the ridge region 50, same as the ridge 55, projects from the tire side portion 31 to the outer side in the tire width direction or to the outer side of the tire, and is provided in and integrally with the tire side portion 31. The projection pattern 60 is formed with a height in the height direction of the ridge 55 with respect to the tire side portion 31 greater than the height of the ridge 55. As a result, the projection pattern 60 is formed so as to project outward from the tire side portion 31 more than the ridge 55. In this manner, the projection pattern 60 formed so as to project outward from the tire side portion 31 more than the ridge 55 extends along the tire side portion 31 and is arranged side by side in the tire circumferential direction.

The projection pattern 60 extending along the tire side portion 31 in the ridge region 50 extends in a direction intersecting the extension direction of the ridge 55. In the present embodiment, the direction of inclination of the projection patterns 60 in the tire circumferential direction with respect to the tire radial direction is opposite to the direction of inclination of the ridge 55 in the tire circumferential direction with respect to the tire radial direction. The plurality of projection patterns 60 whose inclination direction in the tire circumferential direction with respect to the tire radial direction is opposite to the inclination direction of the ridge 55, have the inclination angle θ2 in a range of 10° or more and 80° or less in the tire circumferential direction with respect to the tire radial direction. The inclination angle θ2 of the projection pattern 60 in the tire circumferential direction with respect to the tire radial direction is preferably in a range of 20° or more and 70° or less.

The plurality of projection patterns 60 arranged in the ridge region 50 extend in a direction intersecting the ridge 55, the adjacent projection patterns 60 are arranged at an angle close to parallel to each other, thus the adjacent projection patterns 60 are arranged substantially in parallel, and the plurality of projection patterns 60 are arranged at substantially equal intervals from each other in the tire circumferential direction. Thus, in the ridge region 50, patterns are formed not only by the plurality of ridges 55 but also by the plurality of projection patterns 60. That is, in the ridge region 50, patterns are formed by combining the plurality of ridges 55 and the plurality of projection patterns 60.

The ridge region 50 is arranged along the tire circumferential direction, thus the plurality of projection patterns 60 arranged in the ridge region 50 are arranged substantially radially same as the ridge 55. When the relative angle of the adjacent projection patterns 60 is approximately equal to the relative angle of the arrangement positions of the projection patterns 60 in the tire circumferential direction, the adjacent projection patterns 60 are considered to be substantially parallel.

The plurality of projection patterns 60 arranged in the ridge region 50 include projection patterns 60 in contact with a contour portion 51 of the ridge region 50 on the outer side in the tire radial direction and projection patterns 60 spaced apart from the contour portion 51 of the ridge region 50. That is, the plurality of projection patterns 60 include contact projection patterns 60a that are projection patterns 60 in contact with the contour portion 51 of the ridge region 50 on the outer side in the tire radial direction and non-contact projection patterns 60b that are projection patterns 60 spaced apart from the contour portion 51 of the ridge region 50. These contact projection patterns 60a and non-contact projection patterns 60b are alternately arranged in the tire circumferential direction. The plurality of non-contact projection patterns 60b have the same distance from the radially outer contour portion 51 of the ridge region 50 in the tire circumferential direction.

The plurality of projection patterns 60 arranged in the ridge region 50 are spaced apart from a contour portion 52 of the ridge region 50 on the inner side in the tire radial direction. That is, the plurality of contact projection patterns 60a and the plurality of non-contact projection patterns 60b are spaced apart from the contour portion 52 of the ridge region 50 on the inner side in the tire radial direction. The distances of the projection patterns 60 between each other from the contour portion 52 of the ridge region 50 on the inner side in the tire radial direction are different between adjacent projection patterns 60 in the tire circumferential direction.

In this case, the contour portion 51 on the outer side of the ridge region 50 in the tire radial direction is indicated by a virtual line connecting the respective end portions of the plurality of ridges 55 on the outer side in the tire radial direction arranged in the ridge region 50. Similarly, the contour portion 52 of the ridge region 50 on the inner side in the tire radial direction is indicated by a virtual line connecting the respective end portions of the plurality of ridges 55 on the inner side in the tire radial direction arranged in the ridge region 50.

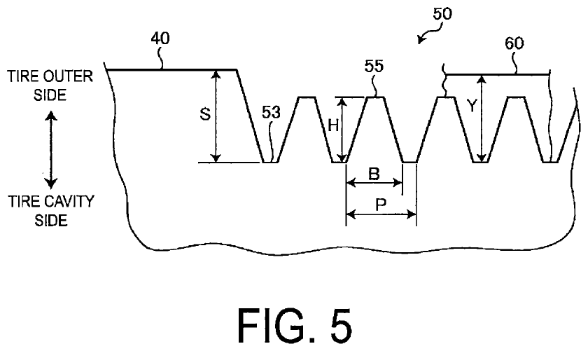

FIG. 5 is a cross-sectional view of the ridges 55 viewed along the extension direction of the ridges 55. The smooth surface region 40 formed in the tire side portion 31 is a planar region in which a height S of the smooth surface region 40 in the height direction of the ridge 55 is greater than the height H of the ridge 55. In this case, the height H of a ridge 55 and the height S of the smooth surface region 40 are the heights in the direction from a ground plane 53 of the ridge region 50 toward the tire outer side.

The ground plane 53 of the ridge region 50 is a plane as the root of the ridge 55 in the ridge region 50 and is a plane recessed from the profile line (not illustrated) toward the tire cavity side. The profile line is a contour line smoothly connecting the shoulder portion 8 and the bead portion 10 in the tire meridian cross-section illustrated in FIG. 1. The profile line is composed of a single arc or a plurality of arcs. The profile line is defined excluding partial unevenness. The height H of the ridge 55 from the ground plane 53 is preferably in a range of 0.50 mm or more and 1.00 mm or less, and the height S of the smooth surface region 40 from the ground plane 53 is preferably in a range of 0.70 mm or more and 1.20 mm or less.

In the projection pattern 60 arranged in the ridge region 50, a height Y of the ridge 55 in the height direction is within a range of ±0.80 mm of the height S of the smooth surface region 40. That is, the height Y of the projection pattern 60 arranged in the ridge region 50 is substantially the same height as the height S of the smooth surface region 40. In this case, the height Y of the projection pattern 60 is the height in the direction from the ground plane 53 of the ridge region 50 toward the tire outer side. The projection pattern 60 arranged in the ridge region 50 preferably has the height Y in the height direction of the ridge 55 within a range of ±0.50 mm of the height S of the smooth surface region 40.

Each of the plurality of ridges 55 arranged in the ridge region 50 preferably has the pitch P, which is the cycle of arrangement of the ridges 55 in the direction in which the ridges 55 are arranged, in a range 0.55 mm≤P≤1.50 mm. Furthermore, the ridge 55 has the ratio H/B of the height H of the ridge 55 to the width B of the ridge 55 in a range 0.60≤H/B≤1.40. The plurality of ridges 55 are arranged substantially radially, thus the adjacent ridges 55 are strictly different in angle from each other, and the pitch P varies depending on the position in the extension direction of the ridge 55, but the pitch P of the ridge 55 is in a range 0.55 mm≤P≤1.50 mm at any position in the extension direction of the ridge 55.

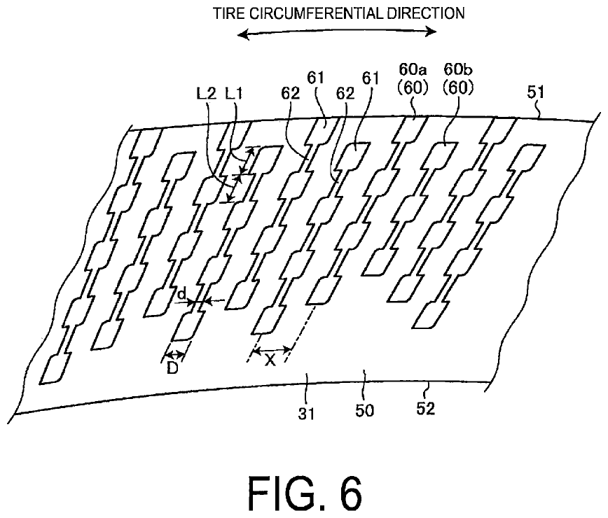

FIG. 6 is a detailed view of a portion B in FIG. 2, and is an explanatory diagram illustrating a state in which the ridges 55 in the ridge region 50 are omitted. FIG. 6 omits illustration of the ridges 55 to facilitate recognition of the projection patterns 60 arranged in the ridge region 50, as FIG. 3. The projection patterns 60 arranged in the ridge region 50 include a broad width portions 61 and narrow width portions 62 having different widths from each other in a direction intersecting the extension direction of the projection patterns 60. The width of the narrow width portion 62 in a direction intersecting the extension direction of the projection pattern 60 is narrower than the width of the broad width portion 61. Each of the plurality of projection patterns 60 arranged in the ridge region 50 includes a plurality of broad width portions 61 and a plurality of narrow width portions 62. The broad width portions 61 and the narrow width portions 62 are formed alternately in the extension direction of each projection pattern 60. That is, the plurality of projection patterns 60 arranged in the ridge region 50 each includes a plurality of broad width portions 61 and narrow width portions 62 in both the contact projection pattern 60a and the non-contact projection pattern 60b, and the broad width portions 61 and narrow width portions 62 are alternately formed in the extension direction of each of the contact projection pattern 60a and the non-contact projection pattern 60b.

In the present embodiment, each of the plurality of contact projection patterns 60a arranged in the ridge region 50 includes the broad width portion 61 in contact with the contour portion 51 of the ridge region 50 on the outer side in the tire radial direction.

The projection pattern 60 including the broad width portion 61 and the narrow width portion 62 has the ratio d/D of the width d of the narrow width portion 62 to the width D of the broad width portion 61 in a range 0.10≤d/D≤0.50. The projection pattern 60 is formed such that the length L1 of the broad width portion 61 in the extension direction of the projection pattern 60 and the length L2 of the narrow width portion 62 in the extension direction of the projection pattern 60 satisfy the relationship 0.30≤L1/(L1+L2)≤0.70.

The relationship between the length L1 of the broad width portion 61 and the length L2 of the narrow width portion 62 of the projection pattern 60 is preferably in a range 0.35≤L1/(L1+L2)≤0.65. In the present embodiment, the length L1 of the broad width portion 61 and the length L2 of the narrow width portion 62 of the projection pattern 60 are approximately the same as each other.

Each of the plurality of projection patterns 60 includes a portion in which the broad width portion 61 of one of the adjacent projection patterns 60 and the narrow width portion 62 of the other of the adjacent projection patterns 60 are at the same position in the tire radial direction. In the present embodiment, the positions of the broad width portion 61 of one projection pattern 60 in the tire radial direction and the positions of the narrow width portion 62 of the other projection pattern 60 in the tire radial direction in the adjacent projection patterns 60 are aligned at the same position in the tire radial direction. In other words, in the adjacent projection patterns 60, the broad width portion 61 of one projection pattern 60 and the narrow width portion 62 of the other projection pattern 60 are adjacent to each other in the tire circumferential direction, and the narrow width portion 62 of one projection pattern 60 and the broad width portion 61 of the other projection pattern 60 are adjacent to each other in the tire circumferential direction.

Each of the plurality of projection patterns 60 arranged side by side in the tire circumferential direction in the ridge region 50 has the pitch X, which is a cycle arrangement of the projection patterns 60 in the direction in which the projection patterns 60 are arranged, in a range 1.00 mm≤X≤5.00 mm. Each of the plurality of projection patterns 60 has a ratio D/X of the width D of the broad width portion 61 to the pitch X of the plurality of projection patterns 60 in a range 0.20≤D/X≤5.00. The plurality of projection patterns 60 are arranged substantially radially, thus the adjacent projection patterns 60 are strictly different in angle from each other, and the pitch X varies depending on the position in the extension direction of the projection pattern 60, but the pitch X of the projection patterns 60 is in a range 1.00 mm ≤X≤5.00 mm at any position in the extension direction of the projection pattern 60.

### Method of Manufacturing Tire

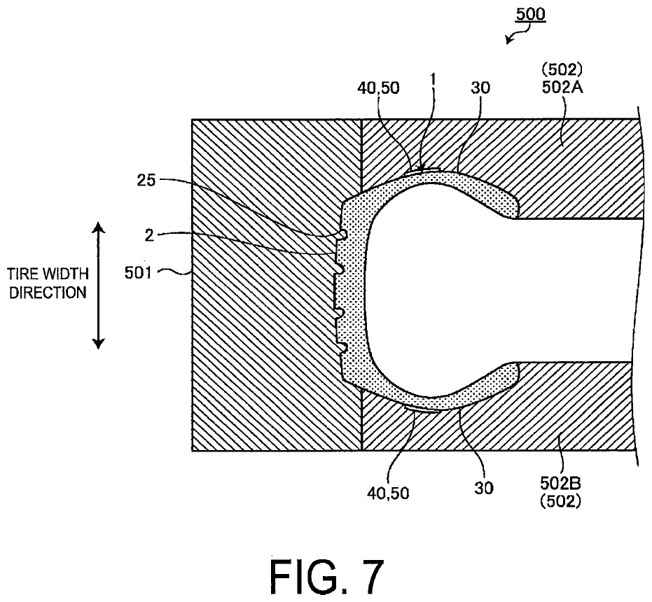

Next, an example of a method of manufacturing the pneumatic tire 1 according to the embodiment will be described. FIG. 7 is a cross-sectional view schematically illustrating a mold 500 for molding a tire, which is a part of a system for manufacturing the pneumatic tire 1. The pneumatic tire 1 is manufactured by vulcanization molding of a green tire as a raw tire, using the mold 500 for vulcanization molding. The green tire is disposed inside the mold 500 and is formed by vulcanization molding while being supported by the mold 500. The mold 500 is arranged in the tire circumferential direction and includes a plurality of sector molds 501 for molding the tread portion 2 of the pneumatic tire 1 and side molds 502 for molding the sidewall portions 30 of the pneumatic tire 1.

The sector mold 501 is members obtained by dividing an annular mold in the tire circumferential direction. A plurality of sector molds 501 are arranged in the tire circumferential direction. Each of the plurality of sector molds 501 is movable in the tire radial direction. The sector mold 501 is brought into contact with the tread portion 2 of the pneumatic tire 1 by moving inward in the tire radial direction. The sector mold 501 is separated from the tread portion 2 of the pneumatic tire 1 by moving outward in the tire radial direction. The plurality of sector molds 501 are integrated by moving inward in the tire radial direction to form an annular mold. The plurality of sector molds 501 are divided by moving outward in the tire radial direction.

The tread portion 2 is formed by sector molds 501. The sector mold 501 includes projection portions so as to project inward in the tire radial direction from the inner surface of the sector mold 501 facing the tread portion 2. A tread pattern design including the circumferential main grooves 25 is formed in the tread portion 2 by the projection portions of the sector mold 501.

The side mold 502 includes an upper side mold 502A and a lower side mold 502B. The pneumatic tire 1 is disposed between the upper side mold 502A and the lower side mold 502B. The upper side mold 502A moves upward away from the sidewall portion 30 of the pneumatic tire 1. The upper side mold 502A moves downward to contact the sidewall portion 30 of the pneumatic tire 1. The lower side mold 502B moves downward away from the sidewall portion 30 of the pneumatic tire 1. The lower side mold 502B moves upward to contact the sidewall portion 30 of the pneumatic tire 1.

The sidewall portions 30 are molded by the side molds 502. The side mold 502 includes uneven portions provided on the inner surface of the side mold 502 facing the sidewall portion 30. The smooth surface regions 40 and ridge regions 50 are formed in the sidewall portion 30 by the uneven portions of the side mold 502.

### Functions and Effects

Next, the functions and effects of the pneumatic tire 1 according to the embodiment will be described. The ridge regions 50 are formed in the tire side portions 31 of the pneumatic tire 1 according to the embodiment, thereby the appearance can be improved. In particular, the plurality of ridges 55 and the plurality of projection patterns 60 intersect in the ridge region 50 of the pneumatic tire 1 according to the embodiment, thus the appearance of the ridge region 50 can be enhanced, and the appearance can be improved more reliably.

When the pneumatic tire 1 is used, the sidewall portion 30 is repeatedly deformed by a load acting on the pneumatic tire 1. The rubber composition constituting the pneumatic tire 1 may deteriorate with age when the pneumatic tire 1 is used for a long period of time. Cracks may occur in the ridge region 50 formed in the tire side portion 31 due to repeated deformation and aging of the sidewall portion 30. Although the ridge region 50 is provided mainly for the purpose of improving the appearance of the pneumatic tire 1, if cracks occur in the ridge region 50, the appearance tends to deteriorate.

On the other hand, in the pneumatic tire 1 according to the present embodiment, in addition to the ridges 55, a plurality of projection patterns 60 having a height greater than the height of the ridge 55 and extending in a direction intersecting the extension direction of the ridges 55 are arranged in the ridge region 50. Thus, for example, even if cracks occur between adjacent ridges 55 and the cracks extend along the extension direction of the ridge 55, when the cracks reach the position of the projection pattern 60, the extension is stopped by the projection pattern 60. As a result, it is possible to suppress the occurrence of long cracks in the ridge region 50 and to suppress the deterioration of the appearance, continuously maintaining the appearance.

On the other hand, in order to form the projection patterns 60 in the ridge region 50, it is necessary to form portions for forming the projection patterns 60 in the mold for forming the ridge region 50 at the time of manufacturing the pneumatic tire 1. The portion of the mold that forms the ridge region 50 is shaped to be capable of forming the plurality of ridges 55. However, if an additional portions for forming the projection patterns 60 are also formed, the man-hours during mold fabrication increase, which may lead to a deterioration in workability during the mold processing.

On the other hand, in the pneumatic tire 1 according to the present embodiment, the plurality of projection patterns 60 formed in the ridge region 50 include the contact projection patterns 60a in contact with the contour portion 51 of the ridge region 50 on the outer side in the tire radial direction and the non-contact projection patterns 60b spaced apart from the contour portion 51, thus it is possible to suppress deterioration of the molding processability accompanying the arrangement of the plurality of projection patterns 60 in the ridge region 50.

That is, the projection patterns 60 includes the contact projection patterns 60a and the non-contact projection patterns 60b, and thus the plurality of projection patterns 60 are formed with different positions at the end portions in the tire radial direction between the contact projection patterns 60a and the non-contact projection patterns 60b. The projection pattern 60 thus formed is formed in a shape projecting to the tire outer side, thus the portion for forming the projection pattern 60 in the mold 500 is formed in a groove-like shape. At this time, the positions of the end portions in the tire radial direction are different between the contact projection pattern 60a and the non-contact projection pattern 60b, thereby the portions for forming the projection patterns 60 in the mold 500 is also formed with different positions of the end portions in the tire radial direction between the portion for forming the contact projection pattern 60a and the portion for forming the non-contact projection pattern 60b. This can improve the workability of the mold processing when forming the portions for forming the projection patterns 60 in the mold 500.

More specifically, when forming the portion for forming the projection pattern 60 in the mold 500 in a groove-like shape, a drill for processing the mold 500 is used. However, the positions of the end portions are different between the portion for forming the contact projection pattern 60a and the portion for forming the non-contact projection pattern 60b in the mold 500, thus the drill can move smoothly and naturally between the end portions of both patterns while continuing the groove-forming process along the extension direction of the projection pattern 60 in moving the drill between the end portion of the both patterns. This can improve workability in forming portions for molding the projection patterns 60 in the mold 500, and thus deterioration in molding processability caused by arranging the plurality of projection patterns 60 in the ridge region 50 can be reduced. As a result, while reducing deterioration in molding processability, it is possible to suppress expansion of cracks and continuously maintain the appearance.

The height Y of the projection pattern 60 is within a range of ±0.80 mm of the height S of the smooth surface region 40, thereby when a crack occurs in the ridge region 50, expansion of the crack can be suppressed by the projection pattern 60 with the secured height. As a result, expansion of the cracks can be more reliably suppressed and the appearance can be continuously maintained.

The projection patterns 60 are arranged in parallel, and thus can more reliably improve the appearance of the ridge region 50 by not only the plurality of ridges 55 but also the plurality of projection patterns 60. The adjacent projection patterns 60 are arranged in parallel, thereby when grooves for molding the projection patterns 60 in the tire side portion 31 are formed in the mold 500 by a drill, the grooves can be formed during movement of the drill in the same direction. This can improve workability in forming portions for molding the projection patterns 60 in the mold 500, and thus deterioration in molding processability caused by arranging the plurality of projection patterns 60 in the ridge region 50 can be reduced. This results in improvement of the appearance while suppressing deterioration in molding processability.

The pitch P of the plurality of ridges 55 arranged in the ridge region 50 is in a range 0.55 mm≤P≤1.50 mm, the tire wax can be appropriately applied to the tire side portion 31 as, for example, a protective layer. That is, the tire wax is sometimes applied to the tire side portion 31 in order to protect and polish the tire side portion 31, but if the pitch P of the plurality of ridges 55 is less than 0.55 mm, the tire wax may be difficult to apply to the ridge region 50 because the pitch P is too small. If the pitch P of the plurality of ridges 55 is greater than 1.50 mm, the tire wax may be easily peeled off when applied to the ridge region 50 because the pitch P is too large.

On the other hand, if the pitch P of the plurality of ridges 55 is in a range 0.55 mm≤P≤1.50 mm, the tire wax can be appropriately applied when applied to the ridge region 50, and the applied tire wax may be difficult to peel off. Thus, the ridge region 50 can be polished by the tire wax, and the ridge region 50 can be protected, thus the occurrence of cracks in the ridge region 50 can be suppressed. This results in enhancing and continuously maintaining the appearance.

The ratio H/B of the height H of the ridge 55 to the width B of the ridge 55 of the plurality of ridges 55 arranged in the ridge region 50 is in a range 0.60≤H/B≤1.40, and thus the effect of the applied tire wax can be maintained for a long time when the tire wax is applied to the ridge region 50. In other words, when the ratio H/B of the height H to the width B of the ridge 55 is less than 0.60, the height H is too low relative to the width B of the ridge 55, thus the tire wax, cannot be protected from external impact when applied to the ridge region 50 and may be easily peeled off. When the ratio H/B of the height H to the width B of the ridge 55 is greater than 1.40, the height H is too high relative to the width B of the ridge 55, thus the penetration of the tire wax between the ridges 55 becomes slow, and the tire wax may be difficult to be efficiently applied to the ridge region 50.

On the other hand, when the ratio H/B of the height H to the width B of the ridge 55 is in a range 0.60≤H/B≤1.40, the tire wax can be efficiently applied to the ridge region 50, and the effect of the applied tire wax can be maintained for a long period of time. This results in enhancing and continuously maintaining the appearance owing to the tire wax applied to the ridge region 50.

The projection patterns 60 include the broad width portions 61 and the narrow width portions 62 alternately formed in the extension direction of the projection pattern 60, thus the extension direction of the crack can be changed in a step shape when the crack generated in the ridge region 50 is extended along the projection patterns 60. This can suppress the extending of the crack for a short time generated in the ridge region 50, reducing deterioration of the appearance. As a result, the extension of the crack can be suppressed, and the appearance can be continuously maintained.

The projection pattern 60 has the ratio d/D of the width d of the narrow width portion 62 to the width D of the broad width portion 61 in a range 0.10≤d/D≤0.50, and thus it is possible to effectively improve the appearance while suppressing the occurrence of vulcanization defects. That is, if the ratio d/D of the width d of the narrow width portion 62 to the width D of the broad width portion 61 of the projection pattern 60 is d/D<0.10, the width d of the narrow width portion 62 is too narrow, thus it is difficult to see the narrow width portion 62 of the projection pattern 60 and to effectively improve the appearance. On the other hand, if the ratio d/D of the width d of the narrow width portion 62 to the width D of the broad width portion 61 of the projection pattern 60 is d/D>0.50, the width d of the narrow width portion 62 is too wide, thus the entire volume of the projection patterns 60 may become too large, and vulcanization defects may easily occur around the projection pattern 60 during vulcanization molding of the pneumatic tire 1.

On the other hand, when the ratio d/D of the width d of the narrow width portion 62 to the width D of the broad width portion 61 of the projection pattern 60 is in a range 0.10≤d/D≤0.50, the width d of the narrow width portion 62 can be appropriately sized, thereby it is possible to effectively improve the appearance by the projection pattern 60 while suppressing the occurrence of vulcanization defects during vulcanization molding of the pneumatic tire 1. This results in reliable improvement of the appearance while suppressing the occurrence of vulcanization defects during manufacturing of the pneumatic tire 1.

The pitch X of the plurality of projection patterns 60 arranged in the ridge region 50 is in a range 1.00 mm≤X≤5.00 mm, thus it is possible to suppress the incidence of vulcanization defects from increasing and to effectively suppress the extension of cracks by the projection patterns 60. That is, if the pitch X of the projection patterns 60 is less than 1.00 mm, the pitch X is too small, thus the occurrence of vulcanization defects during manufacturing of the pneumatic tire 1 may increase because the distance between the adjacent projection patterns 60 is too close. On the other hand, if the pitch X of the projection patterns 60 is greater than 5.00 mm, the pitch X is too large, thus the distance between the adjacent projection patterns 60 is too large, and it may become difficult to effectively suppress by the projection patterns 60, the extension of cracks generated in the ridge region 50.

On the other hand, when if the pitch X of the plurality of projection patterns 60 is in a range 1.00 mm≤X≤5.00 mm, the incidence of vulcanization defects can be suppressed from increasing due to the arrangement of the projection patterns 60 in the ridge region 50, and the extension of cracks generated in the ridge region 50 can be effectively suppressed by the projection patterns 60. As a result, the occurrence of vulcanization defects in manufacturing the pneumatic tire 1 can be suppressed, the extension of cracks can be suppressed, and the appearance can be continuously maintained.

The ratio D/X of the width D of the broad width portion 61 of the projection pattern 60 to the pitch X of the plurality of projection patterns 60 in the plurality of projection patterns 60 is in a range 0.20≤D/X≤5.00, thus the incidence of vulcanization defects can be suppressed from increasing, and the extension of cracks can be effectively suppressed by the projection patterns 60. In other words, if the ratio D/X of the width D of the broad width portion 61 of the projection pattern 60 to the pitch X of the projection patterns 60 is D/X<0.20, the pitch X of the projection pattern 60 is too large, and the distance between the adjacent projection patterns 60 is too large, thus the extension of cracks generated in the ridge region 50 may not be effectively suppressed by the projection patterns 60. On the other hand, if the ratio D/X of the width D of the broad width portion 61 of the projection pattern 60 to the pitch X of the projection patterns 60 is D/X>5.00, the pitch X of the projection patterns 60 is too small, thus the distance between the adjacent projection patterns 60 is too close, and the incidence of vulcanization defects in manufacturing the pneumatic tire 1 may increase.

On the other hand, if the ratio D/X of the width D of the broad width portion 61 of the projection pattern 60 to the pitch X of the projection patterns 60 is in a range 0.20≤D/X≤5.00, the incidence of vulcanization defects can be suppressed from increasing due to the arrangement of the projection patterns 60 in the ridge region 50, and the extension of cracks generated in the ridge region 50 can be effectively suppressed by the projection patterns 60. As a result, the occurrence of vulcanization defects in manufacturing the pneumatic tire 1 can be suppressed, the extension of cracks can be suppressed, and the appearance can be continuously maintained.

In the projection pattern 60, the length L1 of the broad width portion 61 and the length L2 of the narrow width portion 62 satisfy the relationship 0.30≤L1/(L1+L2)≤0.70, thus it is possible to suppress an excessively large difference in area between a portion of the ridge 50 in which the ridge 55 is disposed adjacent to the broad width portion 61 of the projection pattern 60 and a portion in which the ridge 55 is disposed adjacent to the narrow width portion 62. This can suppress the generation of a locally large stress in the ridge region 50 when the sidewall portion 30 is elastically deformed, and can prevent the generation of cracks in the ridge region 50. As a result, the appearance can be continuously maintained.

The projection patterns 60 include portions where the broad width portion 61 of one of the adjacent projection patterns 60 and the narrow width portion 62 of the other of the adjacent projection patterns 60 are at the same position in the tire radial direction. Thus, it is possible to suppress an excessively large difference in area between a portion located between the broad width portion 61 of one projection pattern 60 and the narrow width portion 62 of the other projection pattern 60 and a portion located between the narrow width portion 62 of one projection pattern 60 and the broad width portion 61 of the other projection pattern 60. This can suppress the generation of a locally large stress in the ridge region 50 when the sidewall portion 30 is elastically deformed, and can prevent the generation of cracks in the ridge region 50. This can continuously maintain the appearance.

### Modified Examples

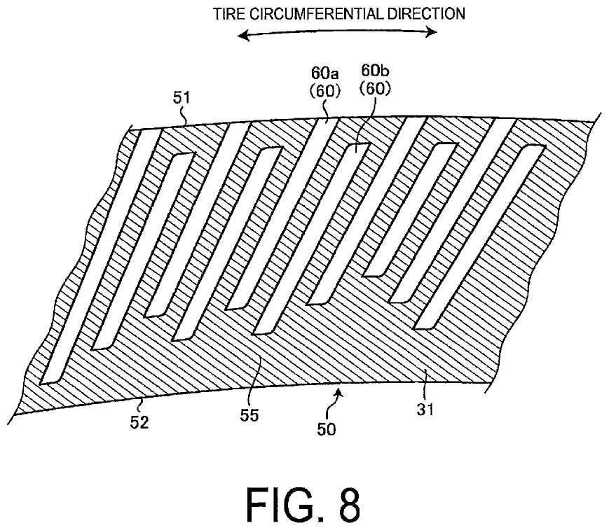

In the embodiment described above, the projection pattern 60 includes the broad width portion 61 and the narrow width portion 62, but the projection pattern 60 may not include the broad width portion 61 and the narrow width portion 62. FIG. 8 is a modified example of the pneumatic tire 1 according to an embodiment, and is an explanatory diagram illustrating a case in which the projection patterns 60 arranged in the ridge region 50 are formed with a constant width. The projection pattern 60 arranged in the ridge region 50 may be formed with a constant width, for example, as illustrated in FIG. 8. The plurality of projection patterns 60 arranged in the ridge region 50 may extend in a direction intersecting the extension direction of the ridge 55 and include a contact projection pattern 60a in contact with the contour portion 51 of the ridge region 50 on the outer side in the tire radial direction and the non-contact projection pattern 60b spaced apart from the contour portion 51 of the ridge region 50.

The plurality of projection patterns 60 arranged in the ridge region 50 each extends in a direction intersecting the extension direction of the ridge 55 and includes the contact projection pattern 60a and the non-contact projection pattern 60b, thus the extension of cracks can be suppressed, and the deterioration of molding processability caused by arranging the projection patterns 60 in the ridge region 50 can be suppressed. As a result, the appearance can be continuously maintained by suppressing the extension of cracks while suppressing the deterioration of molding processability.

In the pneumatic tire 1 according to the embodiment described above, the ridge regions 50 to be provided at two locations of one tire side portion 31 have the same configuration as each other, but the ridge regions 50 to be provided in one tire side portion 31 may have different configurations from each other. That is, the ridge regions 50 may differ from each other in the angle and interval of the ridge 55 arranged in the ridge region 50, the angle and interval and length of the projection pattern 60, the size of the broad width portion 61 and narrow width portion 62 of the projection pattern 60, the order of arrangement of the contact projection pattern 60a and the non-contact projection pattern 60b, the size of the ridge region 50, or the like.

In the pneumatic tire 1 according to the embodiment described above, the ridge regions 50 are provided at 2 locations in 1 tire side portion 31, but may be provided in number other than 2 in 1 tire side portion 31. For example, the ridge regions 50 may be provided at three locations in one tire side portion 31 or may be provided at one location in one tire side portion 31. When the ridge region 50 is provided at one location in one tire side portion 31, the ridge region 50 may be a part of the tire side portion 31 in the tire circumferential direction, or the ridge region 50 may be provided over the entire circumference in the tire circumferential direction. When the ridge regions 50 are provided over the entire circumference of the tire circumferential direction and the smooth surface regions 40 are also provided, the smooth surface regions 40 may be provided at a position different from the ridge regions 50 in the tire radial direction, or may be provided within the ridge region 50.

In the pneumatic tire 1 according to the embodiment described above, the smooth surface regions 40 and the ridge regions 50 each has the same configuration at 2 tire side portions 31 on both sides in the tire width direction. However, the smooth surface regions 40 and the ridge regions 50 may be each provided in different configurations at 2 tire side portions 31 on both sides in the tire width direction. By making the smooth surface regions 40 and the ridge regions 50 different for each tire side portion 31, it is possible to improve the design property, and in the pneumatic tire 1 whose mounting direction to the vehicle is specified, and to suppress the extension of cracks more at the ridge regions 50 of the tire side portion 31 on the side where cracks are likely to occur.

The embodiment and modified examples described above may be combined as appropriate. In the above-described embodiment, the pneumatic tire 1 is used as an example of the tire according to an embodiment of the present technology, but may be other than the pneumatic tire 1. The tire according to an embodiment of the present technology may be, for example, a so-called airless tire that can be used without filling gas.

### Examples

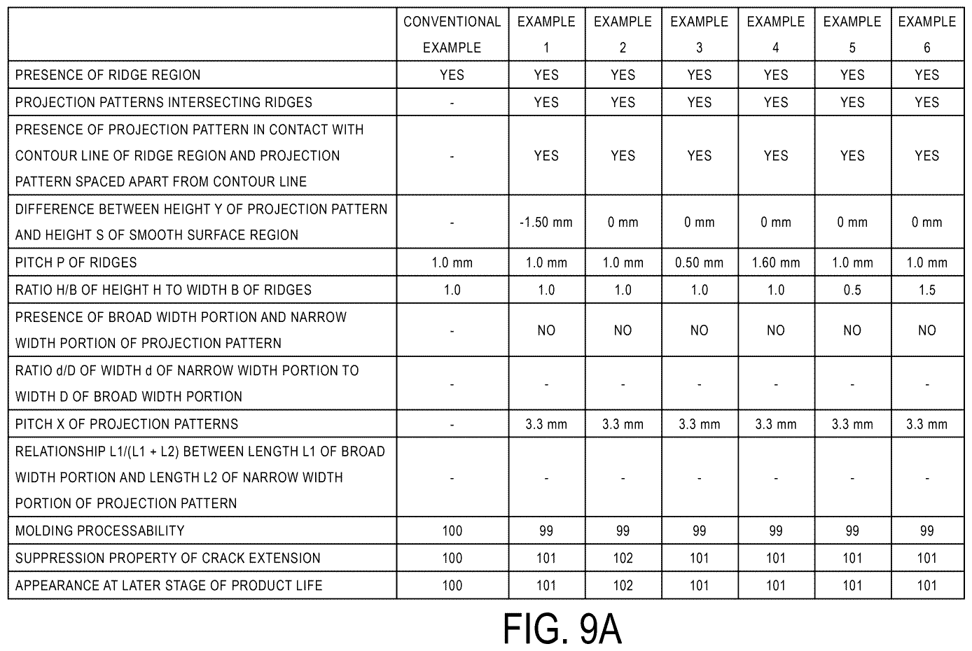

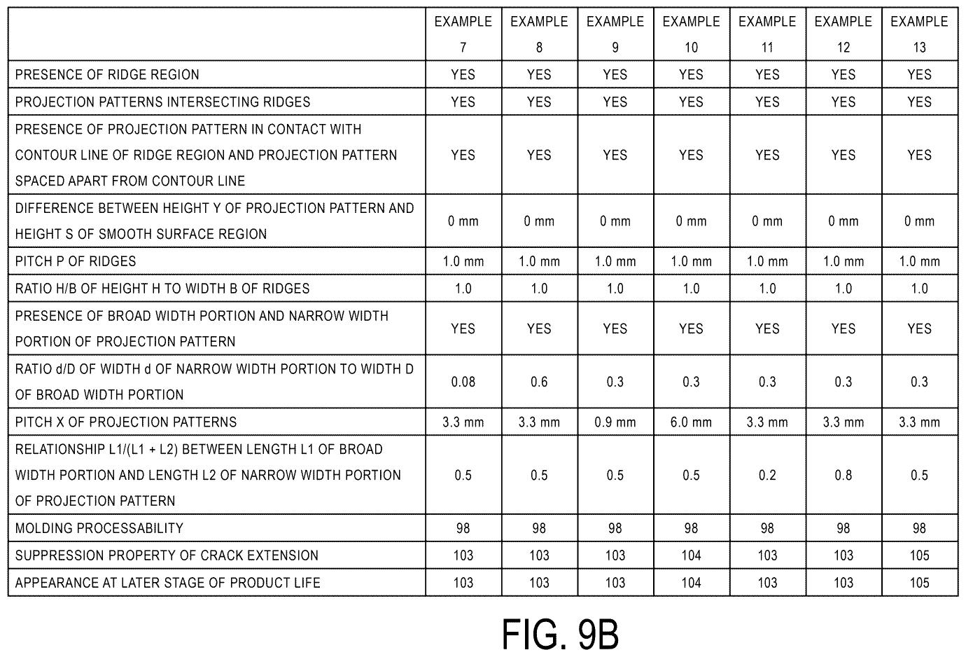

FIGS. 9A-9B include tables describing the results of a performance evaluation test of the pneumatic tire. Hereinafter, a description will be given of a performance evaluation test performed on the pneumatic tire 1 of the conventional example and the pneumatic tire 1 according to an embodiment of the present technology. In the performance evaluation test, molding processability, suppression property of crack extension, and appearance at the later stage of product life were tested.

The performance evaluation test was performed by mounting the pneumatic tire 1 of 235/50R18 size specified by JATMA to a JATMA standard rim wheel of 18×7.5 J rim size.

The molding processability among the evaluation method of each test item, was performed by calculating the cost required for manufacturing the portion of the mold for molding the ridge region 50. The evaluation of the molding processability was performed by index evaluation in which the reciprocal of the calculated cost was set to 100 for the conventional example described below. The larger the numerical value of the index evaluation, the lower the cost required for manufacturing the portion of the mold for molding the ridge region 50, and the better the molding processability. As for the molding processability, when the index value is 98 or more, it is considered that the same level as that of the conventional example is maintained and the deterioration of the molding processability is suppressed.

The evaluation test for the suppression property of crack extension was performed such that an indoor drum test was performed on the test tire using a drum testing machine having a drum diameter of 600 (mm), the test tire was deteriorated by rotating the test tire using the drum testing machine while injecting ozone, and then the test tire was rotated at a high speed while applying a load to the test tire using the drum testing machine. Then, the length of the crack generated in the ridge region 50 of the tire side portion 31 was measured and the number of cracks was counted, and then the total value of the crack length was calculated. The suppression property of crack extension was evaluated by an index evaluation in which the reciprocal of the total calculated crack length was used, with the conventional example described later being set to 100. The suppression property of crack extension indicates that the larger the numerical value of the index evaluation, the smaller the crack extension in the ridge region and the better the suppression property of crack extension.

The appearance in the later stage of the product life was evaluated such that a road test was performed on vehicles equipped with test tires in which aqueous tire wax was applied to the tire side portions 31, and the appearance of the test tires collected after running 4000 km was visually evaluated by an evaluator. The appearance in the later stage of the product life was evaluated by an index evaluation in which evaluation by visual observation of an evaluator was used as an index, with the conventional example described later being set to 100. The appearance in the later stage of the product life indicates that the larger the numerical value of the index evaluation, the less the cracks in the ridge region 50, and the better the appearance in the later stage of the product life.

The performance evaluation test was performed on 14 types of pneumatic tires including a pneumatic tire according to Conventional Example as an example of a known pneumatic tire, and Examples 1 to 13 corresponding to the pneumatic tires 1 according to the embodiment of the present technology. Among these, although the pneumatic tire according to Conventional Example has a ridge region in the tire side portion, no projection pattern is arranged in the ridge region.

In contrast, in all of Examples 1 to 13, which are examples of the pneumatic tire 1 according to an embodiment of the present technology, the projection pattern 60 including the contact projection patterns 60a and the non-contact projection patterns 60b are arranged in the ridge region 50. Furthermore, the pneumatic tires 1 according to Examples 1 to 13 differ from each other in: the difference between the height Y of the projection pattern 60 and the height S of the smooth surface region 40; the pitch P of the ridges 55; the ratio H/B of the height H of the ridge 55 to the width B of the ridge 55; the presence of the broad width portions 61 and the narrow width portions 62 of the projection pattern 60; the ratio d/D of the width d of the narrow width portion 62 to the width D of the broad width portion 61 of the projection pattern 60; the pitch X of the projection patterns 60; and the relationship L1/(L1+L2) between the length L1 of the broad width portion 61 and the length L2 of the narrow width portion 62 of the projection pattern 60.

As a result of an evaluation test using these pneumatic tires 1, as described in FIGS. 9A-9B, it was found that the pneumatic tires 1 according to Examples 1 to 13 can suppress deterioration of molding processability as much as possible when the projection patterns 60 are provided in the ridge region 50 as compared with the Conventional Example, and can improve in the ridge region 50 the suppression property of crack extension, and the appearance in the later stage of product life as compared with the Conventional Example. In other words, the pneumatic tires 1 according to Examples 1 to 13 can suppress crack extension and continuously maintain the appearance while suppressing deterioration of the molding processability.

The present disclosure includes the following technologies.

### Technology [1]

A tire, including:
a ridge region formed on a tire side portion, which is a surface of a sidewall portion, a plurality of ridges being arranged in the ridge region;
a plurality of projection patterns arranged in the ridge region, each having a height in a height direction of the ridges greater than a height of the ridges, and extending in a direction intersecting an extension direction of the ridges,
the plurality of projection patterns including a projection pattern in contact with a contour portion of the ridge region on an outer side in a tire radial direction and a projection pattern spaced apart from the contour portion of the ridge region.

### Technology [2]

The tire according to Technology [1], wherein
a smooth surface region, which is a planar region having a height in the height direction of the ridges greater than the height of the ridges, is formed in the tire side portion, and
the projection pattern has a height in the height direction of the ridges within a range of ±0.80 mm of the height of the smooth surface region.

### Technology [3]

The tire according to Technology [1] or [2], wherein the projection patterns adjacent to each other are arranged in parallel.

### Technology [4]

The tire according to any one of Technologies [1] to [3], wherein each of the plurality of ridges arranged in the ridge region has a pitch P in a range 0.55 mm P≤1.50 mm and a ratio H/B of a height H of the ridges to the width B of the ridges in a range 0.60≤H/B≤1.40.

### Technology [5]

The tire according to any one of Technologies [1] to [4], wherein in the projection patterns, a broad width portion and a narrow width portion having a width in a direction intersecting the extension direction of the projection patterns smaller than a width of the broad width portion are alternately formed in the extension direction of the projection patterns.

### Technology [6]

The tire according to Technology [5], wherein the projection pattern has a ratio d/D of a width d of the narrow width portion to the width D of the broad width portion in a range 0.10≤d/D≤0.50.

### Technology [7]

The tire according to Technology [3], wherein each of the plurality of projection patterns has a pitch X in a range 1.00 mm≤X≤5.00 mm.

### Technology [8]

The tire according to Technology [5] or [6], wherein
the projection patterns adjacent to each other are arranged in parallel, and
each of the plurality of projection patterns has a ratio D/X of a width D of the broad width portion to a pitch X in a range 0.20≤D/X≤5.00.

### Technology [9]

The tire according to any one of Technologies [5], [6], and [8], wherein
the projection pattern has a length L1 of the broad width portion and a length L2 of the narrow width portion in the extension direction of the projection pattern satisfying a relationship 0.30≤L1/(L1+L2)≤0.70.

### Technology [10]

The tire according to any one of Technologies [5], [6], [8], and [9], wherein each of the plurality of projection patterns includes a portion in which the broad width portion of one of the adjacent projection patterns and the narrow width portion of the other of the adjacent projection patterns are at the same position in the tire radial direction.

1. A tire, comprising:
a ridge region formed on a tire side portion, which is a surface of a sidewall portion, a plurality of ridges being arranged in the ridge region;
a plurality of projection patterns arranged in the ridge region, each having a height in a height direction of the ridges greater than a height of the ridges, and extending in a direction intersecting an extension direction of the ridges,
the plurality of projection patterns comprising a projection pattern in contact with a contour portion of the ridge region on an outer side in a tire radial direction and a projection pattern spaced apart from the contour portion of the ridge region.

2. The tire according to claim 1, wherein
a smooth surface region, which is a planar region having a height in the height direction of the ridges greater than the height of the ridges, is formed in the tire side portion, and
the projection pattern has a height in the height direction of the ridges within a range of ±0.80 mm of the height of the smooth surface region.

3. The tire according to claim 1, wherein the projection patterns adjacent to each other are arranged in parallel.

4. The tire according to claim 1, wherein each of the plurality of ridges arranged in the ridge region has a pitch P in a range 0.55 mm≤P≤1.50 mm and a ratio H/B of a height H of the ridges to a width B of the ridges in a range 0.60≤H/B≤1.40.

5. The tire according to claim 1, wherein in the projection patterns, a broad width portion and a narrow width portion having a width in a direction intersecting the extension direction of the projection patterns smaller than a width of the broad width portion are alternately formed in the extension direction of the projection patterns.

6. The tire according to claim 5, wherein the projection pattern has a ratio d/D of a width d of the narrow width portion to a width D of the broad width portion in a range 0.10≤d/D≤0.50.

7. The tire according to claim 3, wherein each of the plurality of projection patterns has a pitch X in a range 1.00 mm≤X≤5.00 mm.

8. The tire according to claim 5, wherein
the projection patterns adjacent to each other are arranged in parallel, and
each of the plurality of projection patterns has a ratio D/X of a width D of the broad width portion to a pitch X in a range 0.20≤D/X≤5.00.

9. The tire according to claim wherein the projection pattern has a length L1 of the broad width portion and a length L2 of the narrow width portion in the extension direction of the projection pattern satisfying a relationship 0.30≤L1/(L1+L2)≤0.70.

10. The tire according to claim 5, wherein each of the plurality of projection patterns includes a portion in which the broad width portion of one of the adjacent projection patterns and the narrow width portion of the other of the adjacent projection patterns are at the same position in the tire radial direction.

11. The tire according to claim 2, wherein the projection patterns adjacent to each other are arranged in parallel.

12. The tire according to claim 2, wherein each of the plurality of ridges arranged in the ridge region has a pitch P in a range 0.55 mm≤P≤1.50 mm and a ratio H/B of a height H of the ridges to a width B of the ridges in a range 0.60≤H/B≤1.40.

13. The tire according to claim 6, wherein
the projection patterns adjacent to each other are arranged in parallel, and
each of the plurality of projection patterns has a ratio D/X of a width D of the broad width portion to a pitch X in a range 0.20≤D/X≤5.00.

14. The tire according to claim 6, wherein the projection pattern has a length L1 of the broad width portion and a length L2 of the narrow width portion in the extension direction of the projection pattern satisfying a relationship 0.3≤L1/(L1+L2)≤0.70.

15. The tire according to claim 6, wherein each of the plurality of projection patterns includes a portion in which the broad width portion of one of the adjacent projection patterns and the narrow width portion of the other of the adjacent projection patterns are at the same position in the tire radial direction.
